(19) United States
(12) Patent Application Publication
(10) Pub. No.: US 2006/0013181 A1
(43) Pub. Date: Jan. 19, 2006

(54) Apparatus, and associated method, for allocating communications in a multi-channel communication system

(76) Inventors: Victor Stolpman, Dallas, TX (US); John Terry, Garland, TX (US)

Correspondence Address: SCHEEF & STONE, L.L.P., 5956 SHERRY LANE, SUITE 1400, DALLAS, TX, 75225, US

(21) Appl. No.: 11/173,642

(22) Filed: Jun. 30, 2005

Related U.S. Application Data
(63) Continuation-in-part of application No. 10/210,743, filed on Jul. 31, 2002.

(51) Int. Cl. H04B 1/69

(52) U.S. Cl. 370/342; 370/441; 375/141

(57) ABSTRACT

Apparatus, and an associated method, for allocating communication data for communication in a multi-channel communication system, such as an OFDM system. An adaptive bit, power, and code rate scheme for a sending station that utilizes LDPC codes selects together bit, power, and code rates of data that are to be communicated upon different ones of the channels in manners that optimize a selected performance criteria.

### CROSS-REFERENCE TO RELATED APPLICATIONS

The present application is a continuation-in-part of patent application Ser. No. 10/210,743 filed on Jul. 31, 2002, the contents of which are incorporated herein by reference.

The present invention relates generally to a manner by which to allocate data for communication upon channels, such as sub-carriers of an OFDM communication system or other channels of a multi-channel communication system, that exhibit variable communication conditions. More particularly, the present invention relates to apparatus, and an associated method, that adaptively allocates data at a sending station in manners to optimize communication of data according to optimization criteria. Allocation is made by selecting the coding rate to be exhibited by an LDPC (Low Density Parity Check) error correcting coder, the modulation level by which the data is modulated, and the power level at which the data is communicated upon the channels. Adaptive reallocation of the communication allocations is made as communication conditions change, based upon changes in channel state information.

### BACKGROUND OF THE INVENTION

Advancements in communication technologies have permitted the development of and deployment of many varied types of communication systems through which to communicate information data. The communication of the data is effectuated between a set of communication stations including at least one sending station and at least one receiving station. The communication stations that are parties to a communication session during which a communication service is effectuated by the communication of the data are interconnected by way of a communication channel. Data sent by a sending station is communicated upon the communication channel for delivery to a receiving station. And, once delivered to a receiving station, the receiving station recovers the informational content of the communicated data.

When the communication channel used in the communication system upon which to communicate the data is formed of a radio channel, the communication system forms a radio communication system. Because radio channels are used upon which to communicate the data, wirelines need not interconnect the communication stations of a radio communication system. Free of the need to interconnect the communication devices with wireline connections, communication stations of a radio communication system are able to be positioned at locations between which wireline connections are unavailable while still permitting communications to be effectuated. Also, a radio communication system is implementable as a mobile communication system in which one or more of the communication stations operable pursuant to a communication session is provided with communication mobility. A cellular communication system is exemplary of a mobile communication system. The network infrastructures of various types of cellular communication systems have been installed over significant portions of the populated areas of the world. Significant numbers of users regularly utilize cellular communication systems through which to communicate both voice and non-voice data. Many times, users communicate through the use of mobile stations, portable, and usually and carryable, devices that operate to transceive communication data with network structure of the cellular communication system. The network structure of the cellular communication systems with which the mobile stations directly communicate are sometimes referred to as base stations or base transceiver stations. As a mobile station travels through a geographical area encompassed by the network of a cellular communication system, the mobile station passes through coverage areas of successive base stations of the system. As the mobile station passes through the coverage areas defined by successive ones of the base stations, communication handoffs are performed between the successive ones of the base stations to permit continued communications with by, and with, the mobile station.

Other types of radio communication systems have been developed that exhibit some of the characteristics of cellular communication systems. Amongst such other radio communication systems are wireless local area networks (WLANs). Wireless local area networks are analogous to cellular communication systems in that communication services are effectuated by the communication of data by, and with, mobile stations that communicate with network structure of the WLANs. In a WLAN, the network structure with which a mobile station communicates is sometimes referred to as an access point (AP). Wireless local area networks are regularly constructed to include a plurality of access points, each defining a coverage area. As a mobile station operable in a WLAN travels between coverage areas defined by different access points, handoffs of communications are permitted to provide for continuity of communications by, and with, the mobile station.

In cellular communication systems, wireless local area networks, and other communication systems, increasingly data-intensive communication services are performed, or desired to be performed. As radio communication systems generally, and cellular communication systems and wireless local area networks, specifically, are generally bandwidth-constrained systems, there is an need to utilize most efficiently the limited radio resources available for communications in such systems. Communications schemes have been set forth by which efficiently to utilize band width allocated to a radio communication system. OFDM (Orthogonal Frequency Division Multiplexing) is a communication scheme that has been developed that efficiently utilizes allocated radio resources. In an OFDM communication scheme, a plurality of orthogonal, or nearly-orthogonal, sub-carriers are defined, each available upon which to communicate data. Other communication schemes have also been developed by which better to utilize the radio resources that are allocated to a communication system. Multi-channel CDMA (Code Division Multiple Access) is another such communication scheme in which channels are defined by unique spreading codes.

Channels defined in an OFDM communication scheme, as well as radio channels defined in other communication schemes, are non-ideal. That is to say, distortion is introduced upon the data that is communicated thereon. The distortion sometimes is time-varying. That is to say, at sometimes, the channel conditions of a single channel might exhibit good communication conditions and permit high data communication-rates at sometimes but exhibit poor communication conditions and permit only low data communication rates at other times. So-called, water-filling techniques have been proposed by which to dynamically allocate communications to different sub-carriers of an OFDM communication scheme, thereby to maximize better the communication capacities of the channels defined upon the respective sub-carriers. As communication conditions on the different sub-carriers change, reallocations of the communication allocations are made. In practice, there are difficulties in carrying out the water-filling techniques. Various adaptive approaches have been proposed and implemented. For instance, adaptively selecting the bit and power loading profiles responsive to the communication conditions have been implemented. And, adaptive coding utilizing non-binary Reed-Soloman (RS) codes has also been implemented. The coding operations performed upon Reed-Soloman coded data utilizes hard-decision decoding.

LDPC (Low Density parity Check) error correcting codes are the subject of recent attention due to the various characteristics that the codes exhibit. Adaptive techniques used in conjunction with Reed-Soloman codes are not extendable to LDPC codes as LDPC decoding operations utilize soft decision decoding.

If a manner were available by which to select adaptively LDPC code rates responsive to communication conditions in an OFDM, or other multi-channel, communication scheme, increased communication capacities in the communication system would be possible.

It is in light of this background information related to communications in a multi-channel radio communication system that the significant improvements of the present invention have evolved.

### SUMMARY

The present invention, accordingly, advantageously provides apparatus, and an associated method by which to allocate data for communication upon channels, such as channels defined upon sub-carriers of an OFDM communication system or other channels of a multi-channel communication system, that exhibit variable communication conditions.

Through operation of an embodiment of the present invention, a manner is provided that adaptively allocates data at a sending station in manners to optimize communication of data according to optimization criteria.

In one aspect ofthe present invention, allocation is made by selecting the coding rate to be exhibited by an LDPC coder, the modulation level by which the data is modulated, and the power level at which the data is communicated upon the channels.

In another aspect of the present invention, a manner is provided that adapts the code rate of an LDPC together with bit and power allocations across the channels of the communication system, e.g., the sub-carriers of an OFDM communication system. Gaussian approximations (GAs) of the bit reliabilities of various bits communicated upon separate channels, e.g., sub-carriers defined in the communication system. The Gaussian approximations of the bit reliabilities are used in adaptive coding and modulation of data communicated in the multi-channel communication system that employs an LDPC error correction system.

A family of metrics is developed that is based upon the AWGN (Average White Gaussian Noise) performance of a family of LDPC codes using, e.g., BPSK (Binary Phase Shift Keying) signaling by which to adjust the LDPC code rate in conjunction with the multi-channel communication system in which channel modulations and power levels are also adaptively controlled. The metrics operate to approximate the error performance of the family of LDPC codes for use with multi-channel systems using channel state information to operate adaptively with respect to the channels.

When implemented in an OFDM system in which sub-carriers are defined, the metrics are used to select the LDPC coding rate together with the modulation level by which the data is to be modulated, and the power levels at which the data is to be communicated upon the respective ones of the sub-carriers.

Implementation of the metrics is carried out, e.g., at a sending station. In another implementation, portions of the procedure and apparatus are carried out at a receiving station, making use of the signaling of the communication system. For instance, if the code rate information pertaining to the LDPC code is sent as part of control signaling delivered to a receiving station, the receiving station benefits from the information but need not implement structure or carry out procedures associated with the communication allocation selection. In another implementation, conversely, if the selected code rate is not sent in control signaling, or otherwise is not supplied to the receiving station, the receiving station, if operable in conformity with an embodiment of the present invention, instead obtains channel state information to determine the selection of code rate, bit, and power allocations.

In another aspect of the present invention, a manner is provided for adaptively selecting the code rate of the coder, the modulation level to be utilized on a sub-carrier by sub-carrier basis, and also the power levels to be used on a sub-carrier by sub-carrier basis. Determination is made of the number of bits per symbol that are needed to obtain a selected data rate for a given code rate. With the determined number of bits, a rate constrained optimization problem is solved to determine values of the bits, i.e., modulation, and power levels for each of the channels given channel state information of the different channels. Thereafter, bit reliability measures are obtained, and then the error performance of a metric of choice is evaluated. If the error metric is less than a minimum, the selected code rate, sub-carrier bit and power allocations are stored. And, as conditions change, the values are reselected, thereby to reallocate the communication allocations to the separate channels.

Various resource allocation configurations are possible for instance, equal bit and equal power allocation profiles for a given code rate is implemented in one configuration. In another configuration, the same information data rate is maintained per OFDM symbol while also considering an equal bit and variable power allocation profile for each channel realization. And, in another configuration, the same fixed code rate and information data rate per symbol are maintained, and both the sub-carrier bits and the power allocation profile are subject to a total power constraint and a total rate constraint that minimizes maximum sub-carrier SER (Symbol Error Rate). And, a configuration in which the same information data rate per OFDM symbol with variants of the code rate, sub-carrier bit and power allocation is also possible.

In these and other aspects, therefore, apparatus, and an associated method, is provided for a sending station operable pursuant to a multi-channel communication scheme to send representations of data bits upon a first communication channel and at least a second communication channel. A coder is adapted to receive the data bits. The coder codes the data bits at a selected code rate into coded form. A selector is adaptive to secure indications of channel state information related to at least one of the first and at least second channels. The selector selects the communication allocation to each of the first and at least second channels upon which to communicate selected portions of the representations of the data. Selection made by the selector of the selected code rate at which the coder codes the data bits is made together with a selected power level and a selected modulation level.

A more complete appreciation of the present invention and the scope thereof can be obtained from the accompanying drawings that are briefly summarized below, the following detailed description of the presently-preferred embodiments of the present invention, and the appended claims.

### BRIEF DESCRIPTION OF THE DRAWINGS

FIG. 1 illustrates a functional block diagram of a communication system in which an embodiment of the present invention is operable.

FIG. 2 illustrates an exemplary biparte graph that represents an LDPC code such as that generated pursuant to operations of an embodiment of the present invention.

FIG. 3 illustrates a plot representative of an exemplary relationship between log-likelihood ratio values and signal strength of a higher order constellation set.

FIG. 4 illustrates an exemplary graphical representation, values of which are used to form a look-up table pursuant to operation of an embodiment of the present invention.

FIG. 5 illustrates a graphical relationship between a puncture code and a resultant code rate exhibit by code words generated by the LDPC code.

FIG. 6 illustrates a flow chart representative of operation of an exemplary embodiment of the present invention.

FIG. 7 illustrates a graphical representation of an exemplary relationship between code and bit error rates used by which to select a code rate pursuant to operation of an embodiment of the present invention.

FIGS. 8 and 9 illustrate exemplary Packet Error Rate performance curves representative of performance provided pursuant to operation of an embodiment of the present invention.

### DETAILED DESCRIPTION

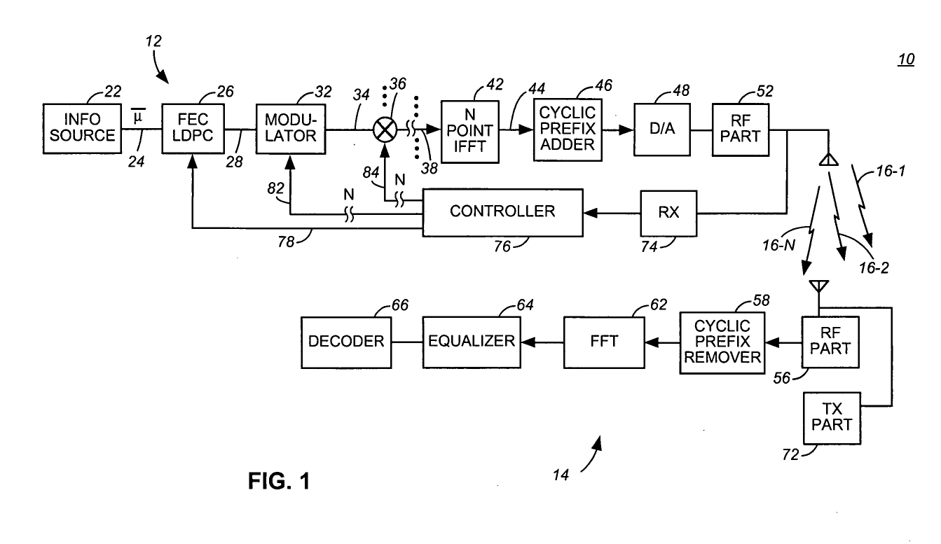

Turning first to FIG. 1, a radio communication system, shown generally at 10, provides for radio communications between a set of communication stations, here represented by a communication station 12 and a communication station 14. While the communication stations 12 and 14, in the exemplary implementation, each form two-way radio transceivers, for purposes of description of operation of an embodiment of the present invention, the communication station 12 shall be referred to as a sending station, and the communication station 14 shall be referred to as a receiving station 14, and communication operations with respect to sending of data from the communication station 12 to the communication station 14 shall be described.

The communication system forms a multi-channel communication system. In the exemplary implementation, the multi-channel communication system forms an OFDM (Orthogonal Frequency Division Multiplexing) communication system in which a plurality of sub-carriers, mutually orthogonal, or nearly so, are defined. The segments 16 are representative of the sub-carriers upon which data sourced at the communication station 12 is communicated to the communication station 14.

In an alternate implementation, the communication system 10 forms a multi-channel CDMA (Code Division multiple Access) communication system in which the channels are defined by spreading codes. The segments 16 are also representative, in such an implementation of the code-defined channels. More generally, the communication system 10 is representative of any multi-channel communication scheme, and the segments 16 are representative of the channels defined in such a communication system and upon which data is communicated during its operation.

As mentioned previously, the channels, i.e., sub-carriers, are not ideal, and distortion is introduced during communication of data thereon. Diversity techniques are provided by which to increase the likelihood of successful communication of the informational content of the data upon the channels that exhibit the non-ideal communication conditions. Transmit diversity, such as that provided by coding the data increased its redundancy to increase the likelihood that the informational content of the data is recoverable even if portions of the data are lost during communication to the receiving station. The increase in redundancy is, however, at the expense of throughput as the increased redundancy reduces the rate at which data can be communicated. When communication conditions are good, lessened amounts of redundancy are required while, when conditions are bad, increased amounts of redundancy are required.

Additionally, when communication conditions are good, the modulation level by which data is modulated for its communication can be higher-order, and the power levels at which the data is communicated can be relatively low. When communication conditions are poor, the modulation level must be lower-order and the power levels must be relatively high to increase the likelihood of successful communication of the informational content of the data.

The sending station is capable of adaptively modifying any of these three parameters pursuant to operation of an embodiment of the present invention.

The sending station is here shown to include an information source 22 at which the data bits m that are to be communicated are sourced. The data bits are provided, by way of the line 24 to an FEC (Forward Error Correcting) LDPC 26. The coder operates to code the information bits provided thereto and to generate code words on the line 28 that are applied to a modulator 32. The modulator generates modulated symbols on the lines 34 that are multiplied at mixer 36 with power signals to form mixed signals on the lines 38 that are applied to an N point IFFT (Inverse Fast Fourier Transformer) 48. The transformer transforms the values provided thereto into the time domain, and the time-domain representations are generated on the line 44 and provided to a cyclic prefix adder 46. The cyclic prefix adder adds cyclic prefixes to the modulated symbols, the resultant values are converted into analog form by a digital-to-analog converter 48, and the analog representations are provided to an RF part 52 that upmixes and amplifies the representations for communication upon the channels 16.

The receiving station includes an RF part 56 that operates, amongst other things, to down-convert the RF-level data representations received at the receiving station. Once down-converted, the cyclic prefixes are removed by a cyclic prefix remover 58. Then, a fast Fourier transform is performed by a fast Fourier transformer 62 to transform the received data into the frequency domain. Thereafter, the received data is equalized by an equalizer 64, and the equalized values are decoded. Decoding operations also include depuncturing operations in the event that puncturing operations are performed by the coder of the sending station.

The receiving station also includes a transmit part, operable to communicate with the sending station. For purposes of operation of an embodiment of the present invention, the transmit part 72 of the receiving station provides feedback information to the sending station for reception at a receive part 74 of the sending station. The feedback information, in the exemplary implementation, is formed responsive to analysis of indicia associated with the received data, its signal strength, accuracy, etc. And, once received at the receive part 74 of the sending station, the feedback information is provided to a controller 76. Operations are performed at the controller together to select the code rate, modulation level, and power level of, the data communicated on the separate ones of the sub-carriers, or channels otherwise defined.

The controller generates signals on the line 78 that is provided to the coder 26 to select the code rate exhibited by the coder. The signals generated on the line 78, for instance, define or instruct use of a puncture pattern to be used. Signals generated on the lines 82 instruct the modulator the modulation-types by which the data to be communicated on the separate sub-carriers are to be modulated. While the modulator 32 is shown as a single block in the figure, the element may also be represented as a series of N blocks, each forming a modulator for the different sub-carriers. And, signals generated by the controller on the lines 84 are provided to the multipliers 36 associated with the different sub-carriers. Thereby, through appropriate selection by the controller, the LDPC coding rate, the modulation scheme, and the power levels are all selectable. And, as the communication conditions change on any of these sub-carriers, the controller permits adaptive change of the operational parameters to reallocate communication allocations on the different sub-carriers.

With respect again to the coder 26, the coder generates LDPC codes. LDPC codes are block codes that get their name from the sparseness of their parity-check matrix, H_{LDPC} of dimension ((N_{LDPC}−K_{LDPC})×N_{LDPC}) where N_{LDPC} is the number of codeword elements (i.e. codeword length) and K_{LDPC} is the number of information elements contained in each codeword (e.g. if using a binary alphabet, K_{LDPC} is the number of information bits).

Often when describing LDPC codes, the distinction of regular and irregular LDPC codes surfaces. Regular (m,k) LDPC codes are codes where each column of H_{LDPC} corresponds to a variable-node (i.e. codeword element) with exactly m non-zero elements and each row of H_{LDPC} corresponds to a check-node (i.e. parity-check equation) with exactly k non-zero elements. On the other hand, irregular LDPC codes allow for heterogeneous non-zero element counts for both rows and columns of H_{LDPC}. Irregular codes can significantly outperform the regular LDPC code constructions.

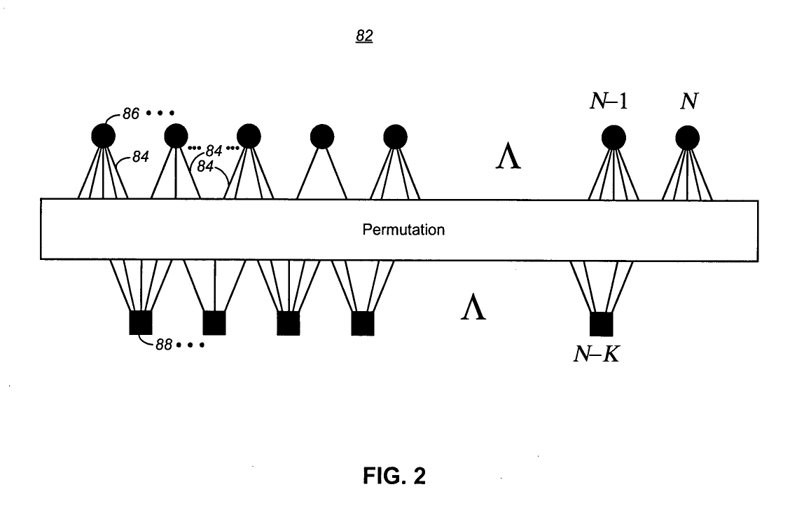

FIG. 2 illustrates an exemplary biparte graph, shown generally at 82. When discussing LDPC codes, a biparte graph (a.k.a. Tanner graph) is often introduced to provide an illustrative representation of LDPC codes. In the biparte graph representation, an “edge” is a line 84 connecting a “variable-node” 86 and a “check-node” 88 corresponding to a non-zero element in the parity-check matrix, H_{LDPC}. Thus, the total number of edges 84 in the biparte graph is equal to the total number of non-zero elements in H_{LDPC}. This variable-to-check node relation corresponds to the connection between a codeword element (variable-node) and an associated parity-check equation (check-node). Thus, variable-nodes are only connected to check-nodes and vice versa (i.e. variable-nodes do not directly connect to other variable-nodes but only connect through a neighboring check-node). The number of edges connected to any particular variable or check-node determines its degree corresponding to the number of ones in the respective column or row of H_{LDPC}.

In decoding LDPC codes, receivers often employ “soft-decoding” of information bits using message-passing (a.k.a. belief-propagation) decoders such as the sum-product algorithm. Although more complicated than hard-decision decoding (e.g. bit-flipping), soft-decision decoding typically holds a significant performance advantage over hard-decision decoding. Because of the sparseness of the parity-check matrix, the soft-decoding complexity for LDPC codes is low enough to be practical for belief propagation techniques. Assuming the sum-product decoder, there are a variety of analysis tools (e.g. Gaussian Approximation (GA) and Density Evolution (DE)) based on the edge polynomials, λ(x) and ρ(x), of the code ensembles to evaluate the performance of the various parity-check matrix constructions. Thus, the effective code rate for the ensemble of punctured LDPC codes described by (λ(x), ρ(X),π⁽⁰⁾(x)) is

$$R ( λ , ρ , {π}^{( 0 )} ) = \frac{R ( λ , ρ )}{1 - {p}^{( 0 )}}$$

$$where {π}^{( 0 )} ( x ) {=}^{def} {\sum }_{j = 2}^{{d}_{l}} {π}_{j}^{( 0 )} {x}^{j - 1} .$$

The communication system 10 shown in FIG. 1 uses LDPC coding for its error control. The system would like to communicate K_{LDPC} bits of information per codeword c_{LDPC} using different code rates by puncturing the code words encoded from a single LDPC mother code derived from (λ(x),ρ(x)) of rate K_{LDPC}/N_{LDPC} where N_{LDPC} is the length of the code words (i.e. number of elements in the each codeword).

Using the LDPC mother code, the transmitter part of the sending station 12 first encodes K_{LDPC} bits of information into N_{LDPC} coded bits where N_{LDPC}>K_{LDPC}. The transmitter part then selects and punctures P_{LDPC}=p⁽⁰⁾N_{LDPC} codeword elements (assumed an integer here but easily accounted for if not) by removing these bits from the codeword elements that are to be modulated and sent through the channel. Given K_{LDPC} and N_{LDPC}, the puncture count, P_{LDPC}ε{0,1, . . . ,N_{LDPC}−K_{LDPC}}, determines the effective code rate of K_{LDPC}/(N_{LDPC}−P_{LDPC}).

At the output of a channel 16, the receive part of the receiving station 14 observes the distorted codeword without the P_{LDPC} punctured bits that were never sent. Before decoding the codeword, the receive part reconstructs the entire codeword by inserting values that do not bias the decoding (i.e. neural with respect of decoding a zero or a one) of punctured bits back into the P_{LDPC} punctured locations (e.g. zero if log-likelihood-ratio values are used as inputs into the sum-product decoder). Using the sum-product iterative soft-decoder, the receive part then decodes the reconstructed codeword attempting to correct any errors due to the communication channel along with the punctured bits.

For each code rate supported by the system, both the transmitter part of the sending station and the receive part of the receiving station must know the puncture locations within the codeword beforehand. One can design a puncture sequence tailored for each particular code rate, but this leads to large memory requirements for long codebooks punctured for a large set of code rates. In the exemplary approach described here, the locations of these P_{LDPC} punctures compose of a single sequence of variable-nodes selected from a single sequence of variable-degrees constructed via a greedy algorithm described in the following subsections. Thus, the puncture sequences for all available code rates,
{K_{LDPC}/N_{LDPC},K_{LDPC}/(N_{LDPC}−1), . . . ,K_{LDPC}/(K_{LDPC}+1),K_{LDPC}/K_{LDPC}},
form encapsulating subsets that form a single puncture sequence S_{N}_{_{LDPC}}_{^{−K}}_{_{LDPC}} of length (N_{LDPC}−K_{LDPC}).
S₁⊂S₂⊂ . . . ⊂ S_{N}_{_{LDPC}}_{^{−K}}_{_{LDPC}}_{^{−1}} ⊂ S_{N}_{_{LDPC}}_{^{−K}}_{_{LDPC}}

Either variable-degrees or variable-node locations in the codeword compose the individual elements of the puncture sequence S_{N}_{_{LDPC}}_{^{−K}}_{_{LDPC}}. Indeed, the sequence's length may be shorter than (N_{LDPC}−K_{LDPC}) if the communication system strictly bounds the maximum code rate below one.

In order to implement a particular code rate, the communication system punctures P_{LDPC} variable-nodes with degrees corresponding to the first P_{LDPC} elements in the degree sequence. The selection of variable-nodes from the puncture degree sequence can be done online or offline. Hence, implementations would use different contiguous subsets of lengths {0,1, . . . , N_{LDPC}−K_{LDPC}−1,N_{LDPC}−K_{LDPC}} to achieve all possible code rates, {K_{LDPC}/N_{LDPC},K_{LDPC}/(N_{LDPC}−1), . . . ,K_{LDPC}/(K_{LDPC}+1),K_{LDPC}/K_{LDPC}} respectively, from the single puncture sequence composed of either variable-nodes or variable-degrees. For a given variable-degree sequence, all node permutations within each individual degree are just different node realizations of that degree sequence. During implementation, communication systems would most likely use a single sequence of variable-nodes and not variable-degrees.

Using the Gaussian Approximation (GA) analysis tools a greedy algorithm is developed that determines a single variable-degree puncturing sequence for a Low-Density Parity-Check (LDPC) code. This approach is different from existing approaches that use Linear Programming (LP) and Density Evolution (DE) techniques.

Additionally, the approach of an embodiment of the present invention differs with an existing approach as the existing approach uses multiple puncturing sequences for the variable-degrees with the nodes chosen at random and thus require a significant amount of memory for a large set of code rates of codewords of long lengths. In the approach of an embodiment of the present invention variable-degree subsets are taken from a single puncture sequence where the subset of the next higher rate contains the subset of the previous lower rate and so forth. For the highest supported code rate, the entire puncture sequence is then used. A significant reduction of required implementation memory for a large set of code rates derived from a single mother code relative to existing approaches is provided.

For the AWGN channel, an Gaussian Approximation (GA) technique, models the messages sent to the check-nodes from the variable-nodes as a linear combination of independent Gaussian random variables. Through empirical study, it has been found that this approximation is fairly accurate for the variable messages sent to the check-nodes using the iterative sum-product decoding algorithms, also known as belief propagation. By only having to track the message means, this approximation simplifies the performance analysis over the previous Density Evolution (DE) that tracks the entire probability density function (p.d.f.) of the variable and check messages used to design LDPC code ensembles.

Gaussian approximation is extended in conventional manners to account for punctured LDPC code ensembles and includes Bit Error Rate (BER) analysis for the punctured code ensemble described by (λ(x),ρ(x),π⁽⁰⁾(x)). As with the conventional GA without puncturing, the approach used pursuant to an embodiment of the present invention for punctured ensembles also tracks the message means along with the probability of a zero variable message (a punctured variable-node) across decoder iterations. An existing approach also derives a convergence criterion that determines the punctured code's threshold for convergence (minimum SNR for error free communications in the asymptotic sense). This existing puncturing approach uses a Linear Programming (LP) approach to maximize the fraction of total variable-nodes punctured given a threshold for the punctured ensemble. Additionally, the existing approach uses Density Evolution (DE) to design the puncture degree sequence. Thus for each effective code rate, the puncturing sequence may be different. The existing LP and DE approaches to puncturing also do not take into account the finite set of code ensembles actually available for a codeword of finite length.

In addition to the convergence threshold of the ensemble, an existing approach further derives an expression for the Bit Error Rate (BER) of the punctured LDPC ensemble based on the message means of the GA. It is this BER expression that an approach of an embodiment of the present invention uses for determining the puncture sequence is based upon, and that provides an approach significantly different than an existing approach.

The mean value update equation for the k^{th} decoder iteration of a punctured LDPC code ensemble during sum-product decoding is defined as

$${m}_{u}^{( k )} = {\sum }_{s = 2}^{{d}_{r}} {ρ}_{s} {ϕ}^{- 1} ( 1 - {\frac{1}{{( 1 - e ( k ) )}^{s - 1}} \\ [ 1 - {\sum }_{j = 2}^{{d}_{t}} \{ {λ}_{j}^{π} {\sum }_{i = 0}^{j - 1} {}_{( j - 1 )}^{}{χ}{}_{i}^{( k )} ϕ ( {im}_{u}^{( k - 1 )} ) + {λ}_{j}^{( 1 - π )} {\sum }_{i = 0}^{j - 1} {}_{( j - 1 )}^{}{χ}{}_{i}^{( k )} ϕ ( {im}_{u}^{( k - 1 )} + {m}_{{u}_{0}} ) \} ]}^{s - 1} )$$

where φ(x) and its inversion φ⁻¹(y) is defined conventionally. Using this GA mean update equation, the BER expression in [6] after the k^{th} decoding iteration is

$${BER}_{GA}^{( k ) =} \underbrace{\frac{{\sum }_{j = 2}^{{d}_{t}} \{ {λ}_{j}^{′} {{π}_{j}^{( 0 )} ( {ɛ}^{( k )} )}^{j} )}{2}}_{unrecovered punctured symbols} + \underbrace{{\sum }_{j = 2}^{{d}_{t}} \{ {λ}_{j}^{′} {π}_{j}^{( 0 )} {\sum }_{i = 1}^{j} {}_{j}^{}{χ}{}_{i}^{( k )} Q ( \sqrt{\frac{{im}_{u}^{( k )}}{2}} )}_{recovered punctured symbols} + \underbrace{{\sum }_{j = 2}^{{d}_{t}} \{ {λ}_{j}^{′} ( 1 - {π}_{j}^{( 0 )} ) {\sum }_{i = 1}^{j} {}_{j}^{}{χ}{}_{i}^{( k )} Q ( \sqrt{\frac{{im}_{u}^{( k )} + n = {m}_{{u}_{0}}}{2}} )}_{bits never punctured}$$

The following describes the aforementioned greedy method of constructing the puncture sequence consisting of the variable-degrees that can be converted to a specific variable-node sequence for any given LDPC realization of the given ensemble.

First, for each variable-degree available for puncturing, calculate the required mean input Log-Likelihood-Ratio (LLR) values, mᵤ_{₀}, that achieve the design criteria (a target BER within a finite number of iterations) on the ensemble of codes using the Gaussian Approximation BER expression for punctured codes, BER_{GA}^{(k)}.

Second, select the variable-degree, j, within the design criteria for puncturing that requires the smallest mean input LLR value and append the degree to the puncturing sequence.

Third, taking into account a specific code length and the finite number of variable-nodes of each degree, adjust the puncturing probability for the punctured variable-degree, πⱼ⁽⁰⁾.

Return to the first step and repeat until the puncturing sequence length corresponds to the Binary Erasure Channel (BEC) threshold for random errors (or if you like until you have a code rate of 1.0). If the fraction of punctured variable-nodes reaches or is beyond the BEC threshold, stop. Note that this greedy algorithm approach could use a different stopping criterion other than the BEC threshold.

Implementation of an embodiment of the present invention is carried at the sending station and may or may not be carried at the receiving station depending on the OFDM system's signalling. For example, if the code rate information of the LDPC code is sent in control signalling to the receiving station, the receiving station benefits but does not have to implement an embodiment of the invention thereat. On the other hand, if the code rate of is not sent in control signalling, the receiving station also utilizes will also use utilize this apparatus with the channel state information, available to both the sending and receiving stations, to determine the code rate, bit and power allocations.

At the receiving station 14, after demodulation in an OFDM communication system, the receiving station obtains the following complex frequency-domain sub-carriers symbols
Yₖ=HₖXₖ+ηₖ for k=1,2, . . . ,N
where Xₖ is the transmitted complex frequency-domain symbol on the k^{th} sub-carrier, Hₖ is the corresponding complex frequency response, and ηₖ is the complex zero mean AWGN with variance σ²=Nₒ/2 for the independent real and imaginary components (i.e. E{ηₖηₖηₖ^{*}}=N₀). The receiving station then uses its channel estimates to equalize the received symbols prior to use in detection and error correction decoding. Assuming perfect Channel State Information (CSI) for the quasi-static channel, the received sub-carrier symbols after equalization are

$${\hat{X}}_{k} = \frac{{Y}_{k}}{{H}_{k}} = {X}_{k} + \frac{{η}_{k}}{{H}_{k}} for k = 1 , 2 , … , N$$

which represents N parallel Gaussian channels each with its own zero-mean independent AWGN. For frequency selective channels, this leads to heterogeneous noise variances across sub-carriers and thus the family of optimization problems based on sub-carrier SER (and BER) that govern digital communication systems that shall be set forth below.

The system 10 of the exemplary implementation uses M-QAM rectangular/cross constellations with a gray bit-mapping scheme for the frequency-domain sub-carrier bit-mapping. From digital communication theory, M-QAM detectors using minimum distance decoding have a symbol error probability εₖ bound by

$${ɛ}_{k} \leq 4 Q ( \sqrt{\frac{2 {\vert {H}_{k} \vert}^{2} {P}_{k}}{( {2}^{{b}_{k} - 1 ) {N}_{o}}}} )$$

where Pₖ=E{XₖXₖ^{*}}, bₖ is the number of bits mapped onto the k^{th} sub-carrier, and the Q(.) function defined as

$$Q ( x ) = \frac{1}{\sqrt{2 π}} {\int }_{x}^{∞} exp ( \frac{- {t}^{2}}{2} ) ⅆ t for 0 \leq x < ∞$$

Thus for a given sub-carrier bit assignment bₖ and frequency response Hₖ, the necessary sub-carrier power needed to achieve the desired SER of εₖ is

$${P}_{k} \geq \frac{{( {Q}^{- 1} ( {ɛ}_{k} / 4 ) )}^{2} ( {2}^{{b}_{k} - 1 ) {N}_{o}}}{3 {\vert {H}_{k} \vert}^{2}}$$

where Q⁻¹(.) is the inverse function of Q(.). Similarly, for a given sub-carrier power and frequency response, the maximum number of bits a sub-carrier may carry per symbol is

$${b}_{k} \leq {log}_{2} ( 1 + \frac{3 {\vert {H}_{k} \vert}^{2} {P}_{k}}{{{N}_{o} ( {Q}^{- 1} ( {ɛ}_{k} / 4 ) )}^{2}} )$$

while maintaining a specified minimum performance εₖ. In the following subsections, we treat the above expressions as equalities when used in the various optimization problems.

Minimization of power given constraints on data rate and sub-carrier SER (Symbol Error Rate) is first considered. In standard form, the first power optimization problem

$$minimize {\sum }_{k = 1}^{N} {P}_{k}$$

$$subject to {\sum }_{k = 1}^{N} {b}_{k} - {R}_{total} \leq 0$$

$${ɛ}_{k} - {\overline{ɛ}}_{k} \leq 0 for k = 1 , 2 , … , N$$

is to minimize the aggregate power with constraints on the total data rate and instantaneous sub-carrier SER's (possibly heterogeneous) where \overline{ε}ₖ is the SER bound on sub-carrier k. Like the maximizing data rate problem, this problem and solution generalizes the approach for heterogeneous sub-carrier symbol error rate bounds for homogeneous sub-carrier SER constraints. The problem using Lagrange multipliers is presented as

$${J}_{p} = {\sum }_{k = 1}^{N} {P}_{k} + λ {\sum }_{k = 1}^{N} {b}_{k}$$

where λ is again the Lagrange multiplier but for the aggregate data rate constraint, and the solution is presented in the following expressions

$${b}_{k} = \frac{{R}_{total}}{N} + {log}_{2} ( \frac{3 {\vert {H}_{k} \vert}^{2}}{{{N}_{o} ( {Q}^{- 1} ( {\overline{ɛ}}_{k} / 4 ) )}^{2}} ) - \frac{1}{N} {\sum }_{i = 1}^{N} {log}_{2} ( \frac{3 {\vert {H}_{i} \vert}^{2}}{{{N}_{o} ( {Q}^{- 1} ( {\overline{ɛ}}_{i} / 4 ) )}^{2}} )$$

$${P}_{k} = {2}^{\frac{{R}_{total}}{N}} ( {\prod }_{i = 1}^{N} {( \frac{{{N}_{o} ( {Q}^{- 1} ( {\overline{ɛ}}_{i} / 4 ) )}^{2}}{3 {\vert {H}_{i} \vert}^{2}} )}^{\frac{1}{N}} ) - \frac{{{N}_{o} ( {Q}^{- 1} ( {\overline{ɛ}}_{k} / 4 ) )}^{2}}{3 {\vert {H}_{k} \vert}^{2}}$$

that minimizes the necessary total power under the given constraints.

In most transmitters, the total transmitter power budget limits the transmitter to some finite power constraint. Thus, the above power solution can be scaled to meet the total power constraint of the transmitter by

$${\tilde{P}}_{k} = \frac{{P}_{total} {P}_{k}}{{\sum }_{i = 1}^{N} {P}_{i}}$$

and thus

$${\sum }_{i = 1}^{N} {\tilde{P}}_{i} = {P}_{total}$$

This results in a solution that potentially exhibits better instantaneous error properties than the original problem requires because the channel may easily able to support the given data rate and error constraints. Nevertheless, the scaled minimum power solution presented above results in near equal sub-carrier SER's and is optimal in the sense that this solution minimizes the maximum instantaneous sub-carrier SER (MinMaxSER). Similarly, additional care is necessitated in implementation to adjust sub-carrier bit allocations due to finite granularity and negative clipping to insure the aggregate rate constraint is met.

Minimization of the average sub-carrier SER given various constraints on sub-carrier power and bit allocations is now considered. This approach has been largely neglected due to the often-made assumption that equal instantaneous sub-carrier error probability is optimal. This is true only in the l₂₈-norm sense where minimizing the average sub-carrier SER is optimal in the l₁-norm sense with respect to sub-carrier SER.

First minimizing the average SER (equivalently the aggregate SER as shown below) subject to a total transmitter power constraint and given sub-carrier bit assignments is considered. Again we can describe the problem in standard form

$$minimize {\sum }_{k = 1}^{N} {ɛ}_{k}$$

$$subject to {\sum }_{k = 1}^{N} {P}_{k} - {P}_{total} \leq 0$$

$$given {b}_{1} , {b}_{2} , … , {b}_{N}$$

or using Lagrange multipliers,

$${J}_{E} = {\sum }_{k = 1}^{N} {ɛ}_{k} + λ {\sum }_{k = 1}^{N} {P}_{k}$$

But unlike the data rate and power problems there is no closed form solution. Instead, an iterative solution is adopted using a constrained steepest descent and backtracking line search. First, the gradient is determined for the nth iteration for our functional as

$$∇ f ( {P}^{( n )} ) = {[ \frac{\partial {ɛ}_{1}}{\partial {P}_{1}} \frac{\partial {ɛ}_{2}}{\partial {P}_{2}} ⋯ \frac{\partial {ɛ}_{N}}{\partial {P}_{N}} ]}^{T}$$

where each element is the partial derivative

$$\frac{\partial {ɛ}_{k}}{\partial {P}_{k}} = - \sqrt{\frac{6 {\vert {H}_{k} \vert}^{2}}{π ( {2}^{{b}_{k}} - 1 ) {N}_{o} {P}_{k}}} exp ( \frac{- 3 {\vert {H}_{k} \vert}^{2} {P}_{k}}{π ( {2}^{{b}_{k}} - 1 ) {N}_{o}} )$$

evaluated using the current sub-carrier power assignment from the vector
P⁽ⁿ⁾=[P₁⁽ⁿ⁾ P₂⁽ⁿ⁾ . . . P_{N}⁽ⁿ⁾]^{T}
If A=1_{(1×N)} where 1_{(1×N)} is a vector of dimension (1×N) consisting of all ones and its transpose be A^{T}=1_{(N×1)}, then
AA^{T}=1_{(1×N)}1_{(N×1)}=N
A^{T} A=1_{(N×1)}1_{(1×N)}=1_{(N×N)}
Now gradient is projected onto the null space of A yielding the direction vector for the n^{th} iteration,

$${g}_{n} = - ⌊ {I}_{( N \times N )} - {{A}^{T} ( {AA}^{T} )}^{- 1} A ⌋ ∇ f ( {P}^{( n )} ) \\ = - [ {I}_{( N \times N )} - {{A}^{T} ( N )}^{- 1} A ] ∇ f ( {P}^{( n )} ) \\ = - [ {I}_{( N \times N )} - \frac{1}{N} {A}^{T} A ] ∇ f ( {P}^{( n )} ) \\ = - [ {I}_{( N \times N )} - \frac{1}{N} {1}_{( N \times N )} ] ∇ f ( {P}^{( n )} ) \\$$

and the update equation for the power allocation

$${P}^{( n + 1 )} = {P}^{( n )} + {α}_{n} \frac{{g}_{n}}{\sqrt{{g}_{n}^{T} {g}_{n}}}$$

with equal power allocation for the initial starting point and where αₙ is the step size on the n^{th} iteration found through a backtracking line search.

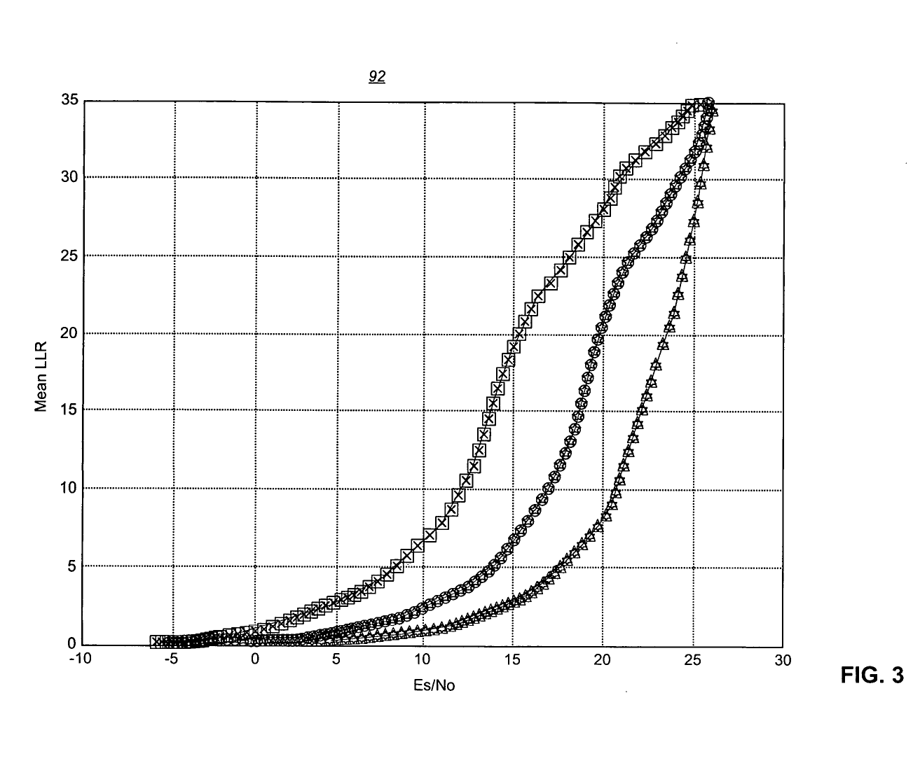

When using higher order modulations such as rectangular/cross M -QAM constellations, the sending station maps multiple bits onto each M -QAM symbol. Each bit location within the mapping has its own error probability translating directly to a measure of reliability relating to the received symbol energy to noise ration denoted as Eₛ/Nₒ. FIG. 3 illustrates a plot, shown generally at 92, of the average sign-adjusted Log-Likelihood-Ratio (LLR) values versus Eₛ/Nₒ in dB for one such constellation example using the gray mapped 64-QAM that maps six bits onto to one of the 64 complex numbers in the constellation. Similar tables can be made for each bit in every modulation order from BPSK up to any M -QAM constellation. Close form expressions for each bit's LLR exist but do not reveal much intuition as to the different bit reliabilities within a constellation and are not presented here.

For each OFDM symbol, there is a total of Rₜₒₜₐₗ number of bits mapped onto the N frequency-domain sub-carrier symbols with bₖ number of bits mapped onto the k^{th} sub-carrier where

$${R}_{total} = {\sum }_{k = 1}^{N} {b}_{k} .$$

The number of bits can be the same for all sub-carriers or different across sub-carriers as in the case when the transmitter performs adaptive modulation given Channel State Information (CSI). Thus, after passing through a particular frequency-selective channel realization, say Hₖ for k=1,2, . . . ,N in the discrete frequency-domain, each of the Rₜₒₜₐₗ received bits will have a corresponding reliability (mean-LLR)
mᵤ_{₀}_{ⁱ} for i=1, . . . Rₜₒₜₐₗ
directly related to the received sub-carrier's symbol to noise ratio.

Similarly, power loaded by the transmitter to each sub-carrier also affects the mean-LLR values. For equal power loading, the transmitter normalizes each constellation for each sub-carrier such that the constellation uses on average unity power (i.e. Pₖ=E{|Xₖ|²}=1 for k=1,2, . . . ,N and thus the received symbol to noise ratio is (Eₛ/N₀)ₖ=|Hₖ|²/Nₒ in natural units), and each point in the constellation is equally likely to occur. Thus, the total power will be equal to the number of sub-carriers (i.e. Pₜₒₜₐₗ=N). Similar to bit loading, the transmitter can also apply power loading to the N sub-carriers when CSI is available at the transmitter subject to the same power constraint,

$${P}_{total} = {\sum }_{k = 1}^{N} {P}_{k} = N$$

In systems where the transmitter exercises power loading techniques, the received symbol to noise ratio for the k^{th} sub-carrier becomes

$${( \frac{{E}_{s}}{{N}_{o}} )}_{k} = \frac{{\vert {H}_{k} \vert}^{2} {P}_{k}}{{N}_{o}} for k = 1 , 2 , … , N$$

where Pₖ is the power allocated to the k^{th} sub-carrier subject to the total power constraint

$${P}_{total} = {\sum }_{k = 1}^{N} {P}_{k} .$$

Adaptation based upon Gaussian approximation is used that takes into account the difference in bit reliabilities in M -QAM modulation constellation to adjust the LDPC coding rate through puncturing along with bit and power allocation. Although not limited to using gray bit mapping, gray bit mapping is used herein pursuant to an exemplary embodiment of the present invention.

The LDPC code rate is adjusted higher through puncturing while inversely varying the total number of bits on each OFDM symbol. Thus, for the same amount of power, we would like to keep the information data rate constant so that the method is comparable to previous results (i.e. rate matched and power matched).

By increasing the LDPC code's rate, fewer Rₜₒₜₐₗ bits are mapped onto the N sub-carriers for the same information data rate resulting in a better bit reliabilities on average observed at the receiver. On the other hand, if the code rate is adjusted too high in exchange for larger mᵤ_{₀}_{^{,i}} for i=1, . . . ,Rₜₒₜₐₗ, the system will suffer due to the lower error correcting capability of the higher rate LDPC code. Thus, it is desired to determine a mechanism (or multiple mechanisms) and algorithm that balances this trade-off that results in better performance than that of a fixed code rate system that uses bit and power allocation.

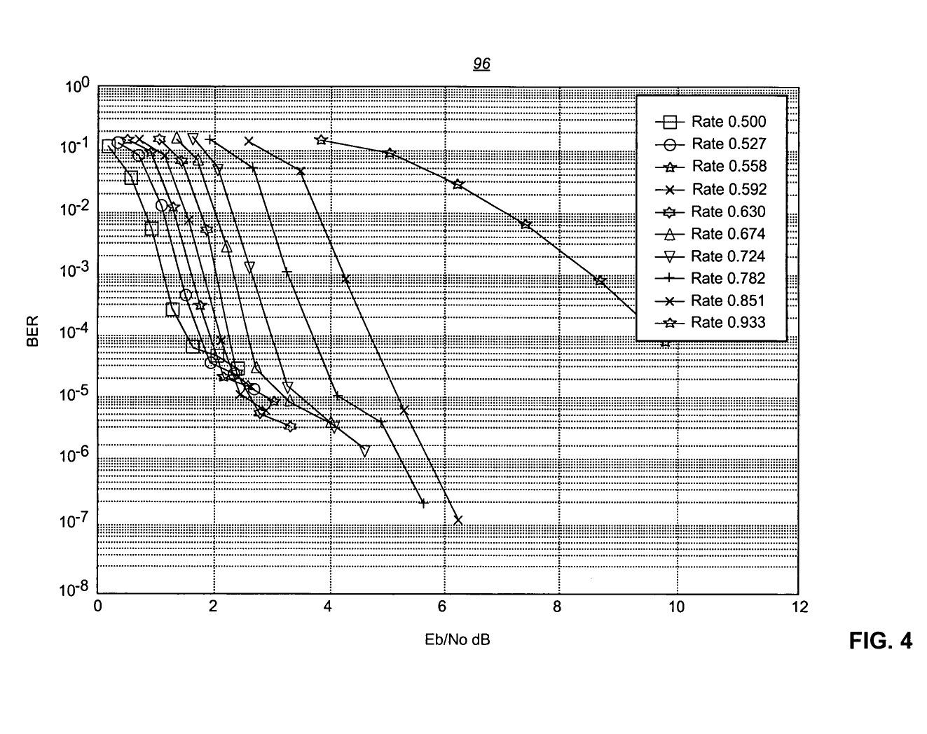

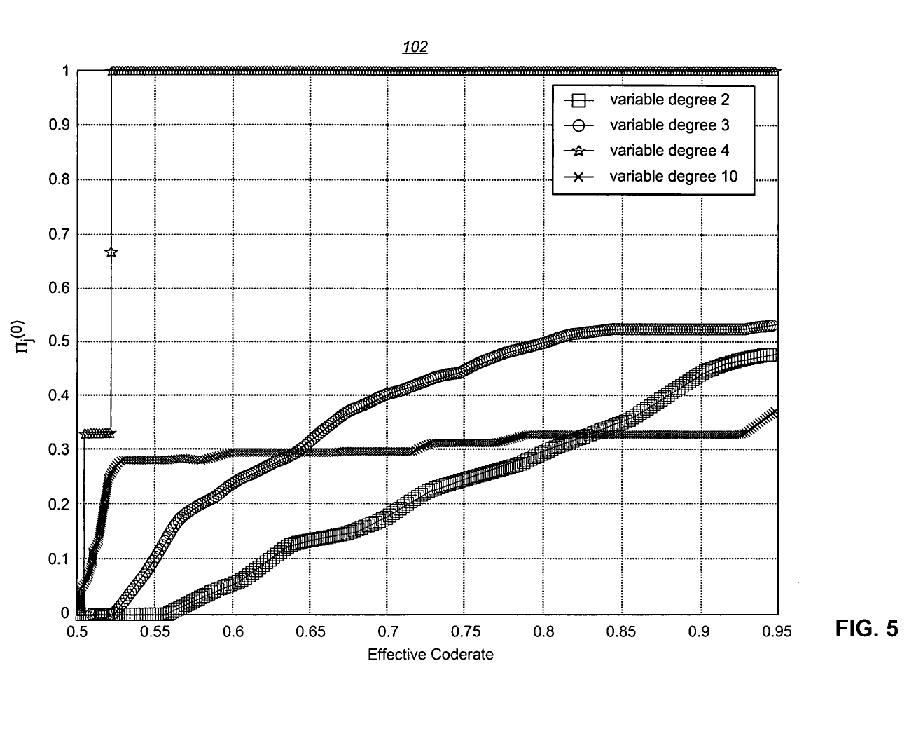

If an approximation is made and each bit of the Rₜₒₜₐₗ bits is interpreted to pass through a Gaussian channel using BPSK signalling, lookup tables containing BPSK BER performance results can be used for that particular code rate in AWGN noise using a specific LDPC mother code realization and puncture sequence. FIG. 4 graphically shows, as shown generally at 96, one such lookup table (BER versus E_{b}/Nₒ) used in the results section for mother code of rate ½ and using the puncture degree sequence, indicated by the plots 102 in FIG. 5, designed using the greedy puncturing method. This is possible because of the direct relationship in the GA between the mean-input-LLR and E_{b}/Nₒ for BPSK in AWGN channels,

$$\frac{{E}_{b}}{{N}_{o}} = \frac{{m}_{{u}_{o}}}{4 \times coderate}$$

By interpolating between points in the lookup table, the BER is approximated as a function of each mᵤ_{₀}_{^{,i}} for i=1, . . . ,Rₜₒₜₐₗ, e.g.

$$BER ( \frac{{m}_{{u}_{0} , i}}{4 \times coderate} ) for i = 1 , … , {R}_{total}$$

By averaging the BER(mᵤ_{₀}_{^{,i}} /(4×coderate)) terms, a metric is created that provides some measure of error performance by which we can optimize the LDPC code rate and transmitter resources (sub-carrier bit and power levels),

$${f}_{\overline{BER} , {m}_{{u}_{0}}} ( {m}_{{u}_{0} , 1} , {m}_{{u}_{0} , 2} , … , {m}_{{u}_{0} , {R}_{total}} , coderate ) {=}^{def} \frac{1}{{R}_{total}} {\sum }_{i = 1}^{{R}_{total}} BER ( \frac{{m}_{{u}_{0} , i}}{4 \times coderate} )$$

Similarly, the average mᵤ₀_{^{,i}} over the Rₜₒₜₐₗ bits is used in a single lookup operation as an alternative approximation to the error performance, i.e.

$${f}_{\overline{BER} , {m}_{{u}_{0}}} ( {m}_{{u}_{0} , 1} , {m}_{{u}_{0} , 2} , … , {m}_{{u}_{0} , {R}_{total}} , coderate ) {=}^{def} BER ( \frac{\frac{1}{{R}_{total}} {\sum }_{i = 1}^{{R}_{total}} {m}_{{u}_{0} , i}}{4 \times coderate} )$$

It is important to note that we can also use a GA lookup table based upon the Codeword Error Rate (CER) versus E_{b}/Nₒ in place of the GA based on BER versus E_{b}/Nₒ, e.g. using

$$CER ( \frac{{m}_{{u}_{0} , i}}{4 \times coderate} ) for i = 1 , … , {R}_{total}$$

additional error approximations are constructed and denoted as ƒ_{\overline{CER}m}_{ᵤ}_{₀} and ƒ_{CER,\overline{m}}_{ᵤ}_{₀} in a similar fashion as above using BER lookup tables.
Yet another error approximation is the GA of the average noise variance. Using the bit-reliability measures

$${m}_{{u}_{0} , i} = \frac{2}{{σ}_{i}^{2}} for i = 1 , … , {R}_{total} ,$$

the GA is used to infer a noise variance of each bit within all the sub-carrier M -QAM symbols.

$${σ}_{i}^{2} = \frac{2}{{m}_{{u}_{0} , i}} for i = 1 , … , {R}_{total}$$

By making an independence assumption, we average the noise variances are averaged

$${σ}_{avg}^{2} = \frac{1}{{R}_{total}} {\sum }_{i = 1}^{{R}_{total}} {σ}_{i}^{2} = \frac{1}{{R}_{total}} {\sum }_{i = 1}^{{R}_{total}} ( 2 / {m}_{{u}_{0} , i} )$$

and calculate an effective input-mean-LLR is calculated through the GA

$${m}_{{u}_{0} , eff} = \frac{2}{{σ}_{avg}^{2}} = \frac{2 {R}_{total}}{{\sum }_{i = 1}^{{R}_{total}} ( 2 / {m}_{{u}_{0} , i} )} = \frac{{R}_{total}}{{\sum }_{i = 1}^{{R}_{total}} ( 1 / {m}_{{u}_{0} , i} )} .$$

Then, mᵤ_{₀}_{^{,eff}} is used with either lookup table (“BER versus E_{b}/Nₒ” or“CER versus E_{b}/Nₒ”) to construct the following error approximations used in adaptive LDPC coding and modulation.

$${f}_{BER , {m}_{{u}_{0} , eff}} ( {m}_{{u}_{0} , eff} , coderate ) {=}^{def} BER ( \frac{{m}_{{u}_{0} , eff}}{( 4 \times coderate )} )$$

$${f}_{CER , {m}_{{u}_{0} , eff}} ( {m}_{{u}_{0} , eff} , coderate ) {=}^{def} CER ( \frac{{m}_{{u}_{0} , eff}}{( 4 \times coderate )} )$$

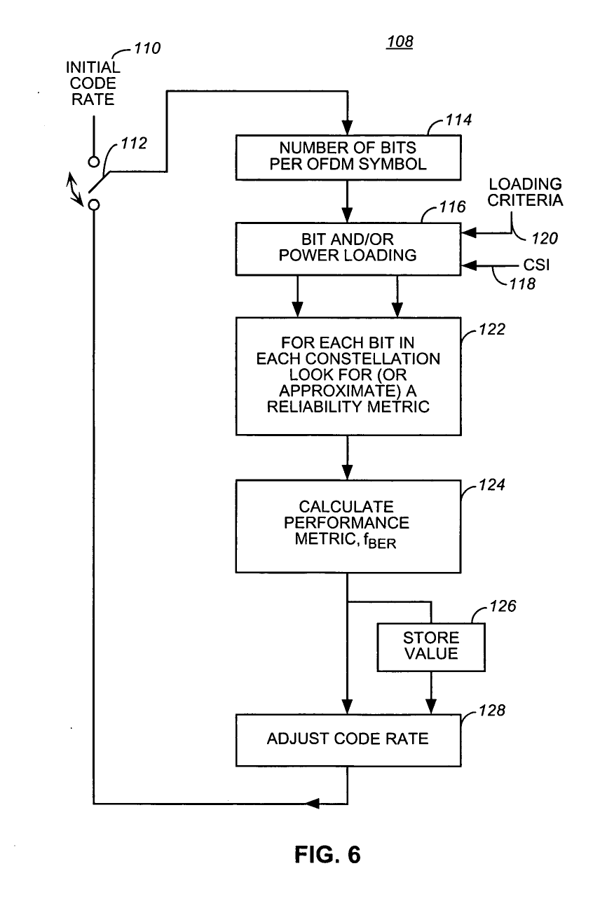

FIG. 6 illustrates an algorithm, shown generally at 108, for adapting code-rate, subcarrier bit and power pursuant to an embodiment of the present invention. Operation starts through use of an initial code rate 110, a specified minimum code rate. Higher code rates selected from a GA lookup table are subsequently used, here indicated by repositioning of the switch position of a switch 112. Subsequent selection is based upon BPSK signaling in the AWGN channel.

First, and as indicated by the block 114, determine the number of bits per OFDM symbol, Rₜₒₜₐₗ, that will meet the specified data rate (e.g. 48 Mbps, 54 Mbps, etc.) given the current code rate.

Then, second, and as indicated by the block 116, use the Rₜₒₜₐₗ from step (114) in the MinMaxSER (or MinMaxBER) rate constrained optimization problem that determines the bit and power solution for all the sub-carriers given CSI, i.e. find bₖ and Pₖ given |Hₖ|²/Nₒ for k=1,2, . . . ,N subject to the total rate and total power constraints

$${R}_{total} = {\sum }_{k = 1}^{N} {b}_{k} and {P}_{total} = {\sum }_{k = 1}^{N} {P}_{k}$$

respectively. The given CSI is indicated by the line 118. It is important to note that this apparatus can work with adaptive modulation and power loading schemes other than those presented here (e.g. adaptive modulation via modulation thresholds, MinMaxBER, etc.), and selection is indicated by the loading criteria line 120.

Third, and as indicated by the block 122, using the bₖ and Pₖ solutions along with |Hₖ|² /Nₒ, determine each bit's reliability measure, mᵤ_{₀}_{^{,i}} for i=1, . . . ,Rₜₒₜₐₗ, using lookup tables consisting of “mᵤ_{₀}_{^{,i}} versus Eₛ/Nₒ” for each of the constellation supported by the system.

Fourth, and as indicated by the block 124, using the current effective code rate and the mᵤ_{₀}_{^{,i}} for i=1, . . . ,Rₜₒₜₐₗ, evaluate the error performance metric of choice (e.g. ƒ_{\overline{BER},m}_{ᵤ}_{₀} , ƒ_{BER,\overline{m}}_{ᵤ}_{₀}, ƒ_{\overline{CER},m}_{ᵤ}_{₀} , ƒ_{CER,\overline{m}}_{ᵤ}_{₀} , ƒ_{BER,m}_{ᵤ}_{₀}_{^{,eff}} or ƒ_{CER,m}_{ᵤ}_{₀}_{^{,eff}}) using GA lookup tables based on BPSK signalling consisting of either “BER versus E_{b}/Nₒ” or “CER versus E_{b}/Nₒ” depending on the metric of choice.

Fifth, and as indicated by the block 126, if the error metric is less than or equal to the minimum metric calculated thus far, store the code rate, sub-carrier bit and power allocations for return. For each code rate, e.g., the same error approximation metric is used to compare with other effective code rates.

Sixth, and as indicated by the block 128, if the maximum code rate in lookup tables has not been evaluated, then increment code rate to the next higher in the GA lookup table and return to the first step.

Seventh, and also indicated by the block 128, if the maximum code rate in table has been evaluated, then stop and return the code rate, sub-carrier bit and power solutions that yield the minimum error metric that has been stored during the search.

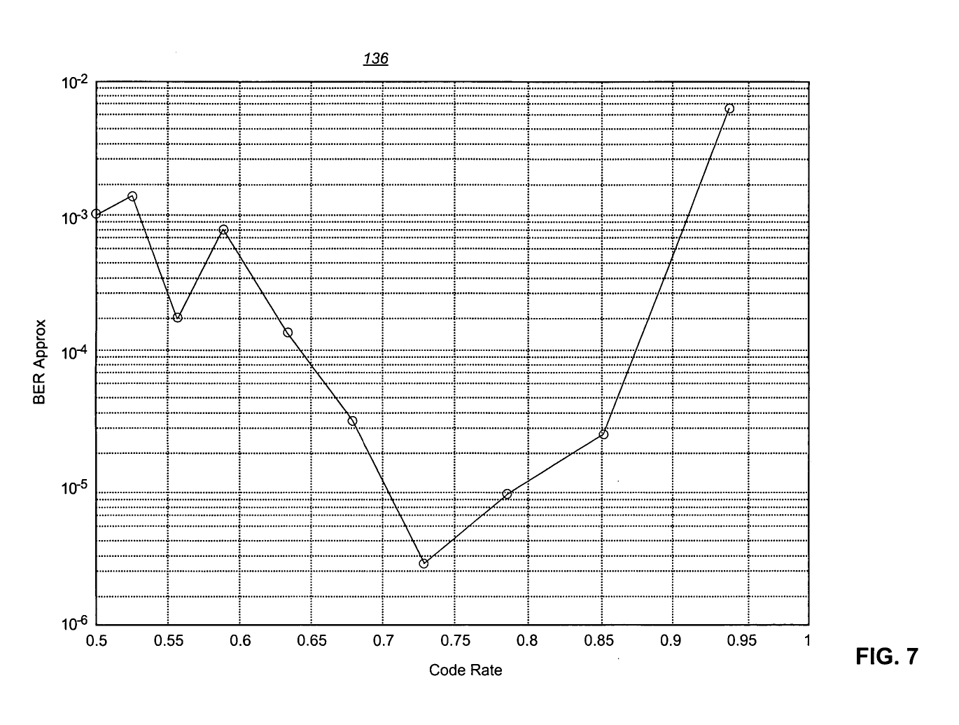

Using ƒ_{\overline{BER},m}_{ᵤ}_{₀} as the error metric, FIG. 7 illustrates graphically, shown generally at 136, the choice of code rate for a minimum code rate of ½ using its corresponding lookup table in FIG. 4 and a 36 Mbps data rate for a single given channel realization.

Four resource allocation configurations that are considered:

The first is equal bit and equal power allocation profiles for a given code rate. This approach uses only a single QAM constellation across sub-carriers, and, hence, for a fixed number of sub-carriers a fixed data rate, and uniformly distributes transmitter power across sub-carriers. This approach does not require channel state information.

Maintaining the same information data rate per OFDM symbol as the first approach, we also consider an equal bit and variable power allocation profile designed for each channel realization according to the approach that minimizes the average sub-carrier SER (MinAvgSER). This approach uses only a single QAM constellation across sub-carriers and varies the sub-carrier power using the CSI.

Again maintaining the same fixed code rate and information data rate per OFDM as the previous two approaches, the third approach is to vary both the sub-carrier bits and power allocation profiles subject to a total power constraint and a total rate constraint via the approach mentioned above that attempts to minimize the maximum sub-carrier SER (MinMaxSER). Like the second approach, this approach tries to take advantage of CSI at the transmitter.

The fourth approach maintains the same information data rate per OFDM symbol, but it varies the code rate, sub-carrier bit and power allocation as to the algorithm set forth above.

Using the 48 Mbps and 54 Mbps information data rate modes of operation, the four approaches are compared along with the corresponding convolutional code (CC) and interleaver used in the IEEE802.11a standard for the same size packet. In both simulations, the packet sizes correspond to the number of information bits per packet frame (203 information bytes per packet).

Using a fixed LDPC code rate, the first three configurations considered constrain both the number of physical bits per OFDM symbol to 288 (i.e. Rₜₒₜₐₗ=288 for an average of 6 bits per sub-carrier) and the total power such that on average a unit per sub-carrier used for data transfer, e.g., Pₜₒₜₐₗ=48 for the system also described herein. In the two simulations, these first three punctured LDPC code approaches used the two coding rates of ⅔ and ¾ corresponding to data rates of 48 Mbps and 54 Mbps, respectively.

Using a variable LDPC code rate, the fourth approach constrains the number of bits per OFDM to no more than 288 (i.e. Rₜₒₜₐₗ≦288) and the total power such that on average a unit per sub-carrier used for data transfer (i.e. Pₜₒₜₐₗ=48). For the 48 Mbps mode, the rate ½ LDPC code is punctured up to a minimum of a ⅔ rate code, and for the 54 Mbps mode, the rate ½ LDPC code is punctured up to a minimum of a ¾ rate code. In the two simulations, the effective code rate, sub-carrier bit and power solutions follow: subsection titled “Algorithm for Adapting Code Rate, Sub-Carrier bit and Power” using the ƒ_{\overline{BER},m}_{ᵤ}_{₀} expression as the error metric.

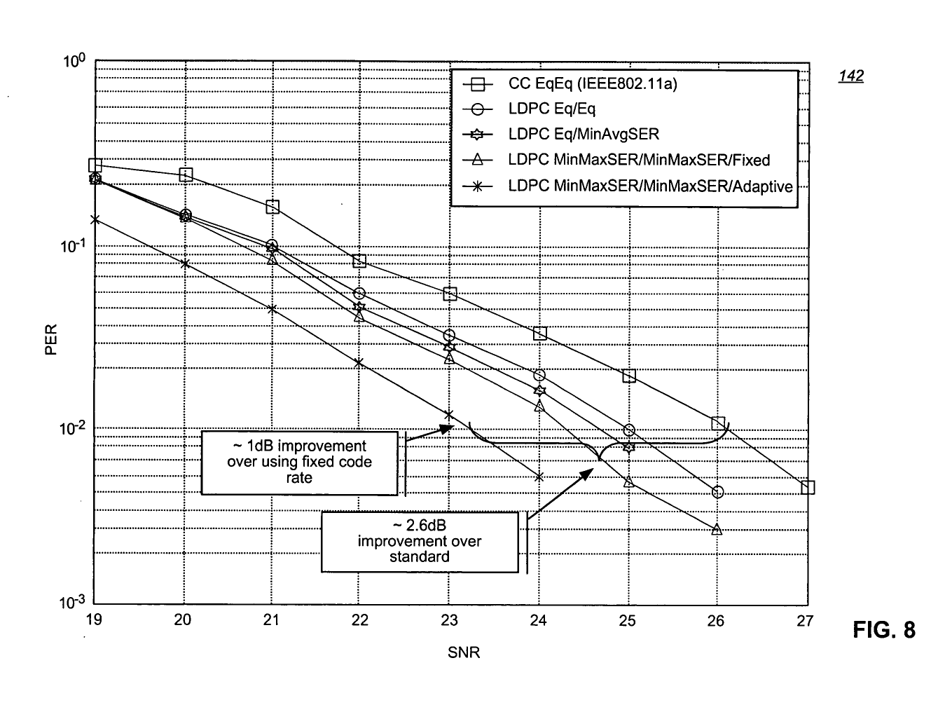

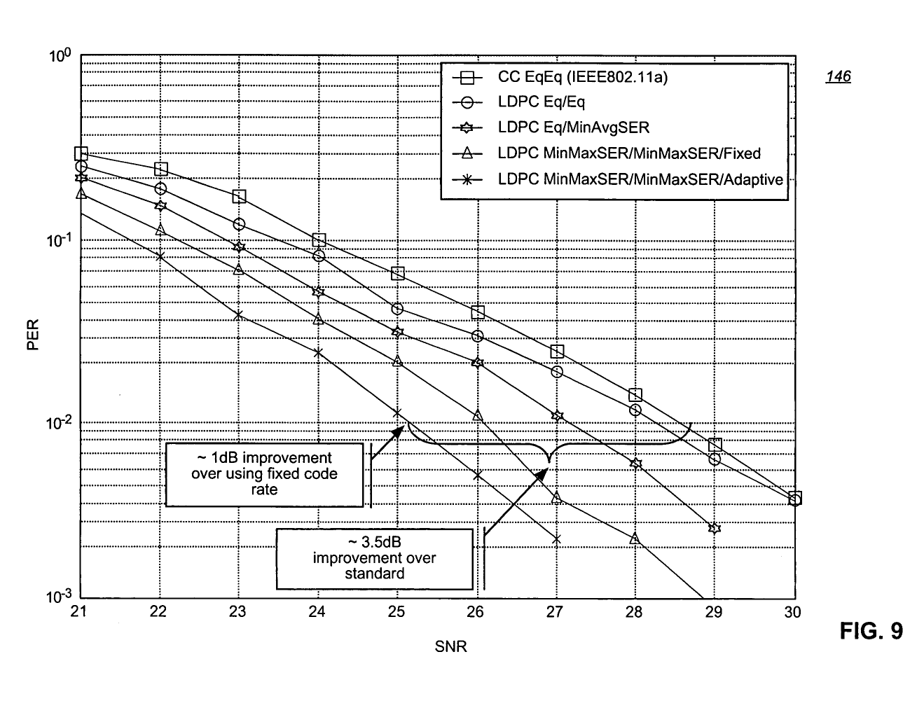

FIGS. 8 and 9 show the Packet Error Rate (PER) performance of the four approaches compared with the convolutional code for the 48 Mbps and 54 Mbps modes respectively. Again, curves, shown generally at 142 in FIG. 8 and 146 in FIG. 9 are rate and power matched as per the description above. For the equal bit allocation approaches, each sub-carrier modulation used 64-QAM (i.e. 6 bits per sub-carrier). For the variable bit allocation approach, the modulation on any given sub-carrier can range from no modulations (i.e. no bits in spectral nulls) all the way up to a maximum of 12 bits, generally unlikely to occur, but nevertheless, for the first three approaches the total number of bits was still 288 per OFDM symbol. As for the fourth, the total number of bits varied accordingly as to adjust for the code rate adjustments while maintaining a constant information date rate matched with the fixed code rate cases.

For the 48 Mbps mode where the LDPC code was punctured from a rate ½ code to a rate ⅔ code, the LDPC code out performed the existing convolutional code and interleaver by at least 1 dB using no adaptation and up to 2.6 dB using full adaptation (i.e. bits, power, and code rate) at a PER=0.01. More importantly, by adapting the LDPC code rate we are able to improve upon the fixed code rate by about 1 dB in SNR performance.

For the 54 Mbps mode where the LDPC code was punctured from a rate ½ code to a rate ¾ code, the LDPC code maintained superior performance over the existing convolutional code and interleaver with improvements reaching 3.5 dB using full adaptation (i.e. bits, power, and code rate) at a PER=0.01. Again for the LDPC code, the adaptive code rate approach outperformed the fixed code rate by about 1 dB in SNR performance.

A large improvement using the variable bit and variable power over the equal bit approaches is evident from review of the FIGS. 8 and 9. As with all coded systems employing soft-decision decoding, bit loading and variable power allocation becomes more important at higher code rates because there are less degrees of freedom within the error correction code to overcome the negative performance attributed to nulls in the spectrum. Through adaptive bit and power loading, the negative impact of such nulls is reduced by not placing any bits and not wasting any power in these spectral nulls. The other reason we attribute the significant gains using the water-filling-like approach is because on a bit stream perspective the channel appears more similar to the AWGN channel that the LDPC code and its puncture sequence were designed for (i.e. on average there is less variation in the effective channel each bit experiences).

The previous descriptions are of preferred examples for implementing the invention, and the scope of the invention should not necessarily be limited by this description. The scope of the present invention is defined by the following claims.

We claim:

1. Apparatus for a sending station operable pursuant to a multi-channel communication scheme to send representations of data bits upon a first communication channel and at least a second communication channel, said apparatus comprising:
a coder adapted to receive the data bits, said coder for coding the data bits at a selected code rate into coded form;
a selector adapted to secure indications of channel state information related to at least one of the first and at least second channels, said selector for selecting the communication allocation to each of the first and at least second channels upon which to communicate selected portions of the representations of the data, selection made by said selector of the selected code rate at which said coder codes the data bits together with a selected power level and a selected modulation level.

2. The apparatus of claim 1 wherein said coder comprises a binary coder and wherein the coded form into which said coder codes the data bits according to the selected coding scheme comprises a binary-coded form of the data bits.

3. The apparatus of claim 2 wherein said binary coder forming said coder comprises an iterative coder having a puncture sequence.

4. The apparatus of claim 1 wherein said coder comprises a low density parity check LDPC coder that exhibits an adaptively selectable coding rate.

5. The apparatus of claim 1 wherein the multi-channel communication scheme comprises an orthogonal frequency division multiplexing scheme and wherein the communication allocation selected by said selector comprises communication allocation to each of a first and at least second sub-carriers defined in the orthogonal frequency division multiplexing scheme.

6. The apparatus of claim 1 wherein the multi-channel communication scheme comprises a multi-carrier code division multiple access CDMA scheme and wherein the communication allocation selected by said selector comprises communication allocation to each of a first and at least second carrier defined in the multi-carrier CDMA scheme.

7. The apparatus of claim 1 wherein the sending station further comprises a modulator for separately modulating the representations of the data bits that are sent upon the first communication channel and the at least the second communication channel, and wherein said selector further selects the selected modulation level at which the representations of the data bits are separately modulated upon the first and at least second communication channels.

8. The apparatus of claim 1 wherein the selected optimization criteria according to which said selector selects the communication allocation optimizes a collective data throughput rate upon the first and at least second communication channels.

9. The apparatus of claim 8 wherein the selected optimization criteria according to which said selector selects the communication allocation further optimizes the collective data throughput rate at least at selected performance levels upon the first and at least second communication channels.

10. The apparatus of claim 9 wherein the selected optimization criteria according to which said selector selects the communication allocation further optimizes the collective data throughput rate at a total power level less than a maximum power level.

11. The apparatus of claim 8 wherein the selected optimization criteria according to which said selector selects the communication allocation optimizes the collective data throughput rate at an optimal power level.

12. The apparatus of claim 11 wherein the selected optimization scheme according to which said selector selects the communication allocation further optimizes the collective data throughput rate at a level less than a maximum throughput rate level.

13. The apparatus of claim 8 wherein the selected optimization scheme according to which said selector selects the communication allocation optimizes the collective data throughput rate at least to attain a symbol error rate beneath a maximum symbol-error-rate level.

14. The apparatus of claim 13 wherein the said selected optimization scheme according to which said selector selects the communication allocation further optimizes the collective data throughput rate at a collective power level less than a maximum power level.

15. A method for facilitating sending, by a sending station operable pursuant to a multi-channel communication scheme, representations of data bits upon a first communication channel and at least a second communication channel, said method comprising the operations of:
detecting channel state information associated with at least one of the first and at least second communication channels;
selecting, responsive to the channel state information detected during said operation of detecting, a selected coding scheme by which to code the data bits into coded form according to a selected optimization criteria; and
selecting, responsive to the channel state information detected during said operation of detecting, the communication allocation to each of the first and at least second channel upon which to communicate selected portions of the representations of the data, once coded into the coded form, according to the selected optimization criteria.

16. The method of claim 15 wherein the selected coding scheme comprises a low density parity check LDPC coding scheme that exhibits a selectable coding rate and wherein said operation of selecting the selected coding scheme comprises selecting the coding rate.

17. The method of claim 15 wherein said operations of selecting the selected coding scheme and of selecting the communication allocation are together performed pursuant to the selected optimization criteria.

18. The method of claim 15 wherein the selected coding scheme selected during said operation of selecting the coding scheme selected during said operation of selecting the coding scheme comprises a binary coding scheme.

19. The method of claim 15 wherein the selected optimization criteria comprises an optimizing parameter together with a constraint parameter.

20. Apparatus for a receiving station operable pursuant to a frequency-multiplexed communication scheme to receive representations of coded data bits sent upon a first communication channel and at least a second communication channel, said apparatus comprising:
a determiner adapted to receive indications of the coded data bits sent upon the first and at least second channels, once delivered to the receiving station, said determiner for determining channel state information associated with at least one of the first and at least second channels; and
a profile indicia generator adapted to receive the channel state information determined by said determiner, said profile indicia generator for generating channel profile indicia, the channel profile indicia for use by the receiving station to operate upon the coded data bits.

21. Apparatus that selects a selected code rate at which to code data at a communication station, said apparatus comprising:
a determiner adapted to receive an initial code rate, said determiner determining a symbol size required of symbols into which the data is to be modulated to be communicated using the initial code rate;
a performance calculator adapted to receive values responsive to determinations made by said determiner, said performance calculator calculating a performance indicia associated with communication of the data at the initial code rate and determining, responsive thereto, whether a code-rate increase improves performance of communications; and
a selected code rate selector for selecting the selected code rate responsive to calculations made by said performance calculator.
